(19) United States
(12) Patent Application Publication
(10) Pub. No.: US 2004/0219470 A1
(43) Pub. Date: Nov. 4, 2004

(54) Orthodontic bracket and method of debonding a bracket

(75) Inventor: Farrokh Farzin-Nia, Inglewood, CA (US)

Correspondence Address: WOOD, HERRON & EVANS, LLP, 2700 CAREW TOWER, 441 VINE STREET, CINCINNATI, OH, 45202, US

(73) Assignee: Ormco Corporation

(21) Appl. No.: 10/428,292

(22) Filed: May 2, 2003

(51) Int. Cl. A61C 3/00

(52) U.S. Cl. 433/3; 433/4

(57) ABSTRACT

An orthodontic bracket comprises a bracket body, a base on the bracket body, and mechanical bonding structure on the base. An adhesive is applied to and mechanically bonded with the mechanical bonding structure to secure the bracket body and the base to a tooth. A portion of the base has a bond strength with the adhesive which is reduced relative to the bond strength between the remainder of the base and the adhesive. A debonding method includes applying a debonding force to the bracket at a first area of reduced adhesion between the bracket and the tooth, and removing the bracket from the tooth.

### FIELD OF THE INVENTION

The present invention relates generally to orthodontic brackets and debonding techniques used for removing the orthodontic brackets from the teeth of a patient.

### BACKGROUND OF THE INVENTION

One of the major challenges associated with the use of brackets for orthodontic treatment is the removal of the brackets from the teeth of the patient. Metal brackets are generally removed by pinching the bracket in a generally mesio-distal or diagonal direction using a pair of pliers, such as so-called Weingart pliers. The pliers apply compressive forces and pinch the brackets generally in a mesio-distal direction, typically by placing the jaws of the pliers diagonally across the bracket and engaging tie-wings opposite corners of the bracket, for example, at the gingival/mesio and occlusal/distal corners of the bracket. Pinching the bracket in this manner results in deformation of the ductile bracket body as well as the debonding pad used to attach the body of the bracket to the tooth surface. This deformation causes the interface between the adhesive and the bonding pad or bracket base to separate or fracture, thereby essentially peeling the bracket away from the tooth surface as the adhesive material debonds.

Brittle orthodontic bracket materials, such as ceramic materials, are much more problematic during the bracket debonding process. These bracket materials are extremely hard and non-ductile relative to materials, such as stainless steel, typically used for metal brackets. Ceramic materials also have a low fracture toughness relative to steel and other metals, meaning that ceramic material is much more prone to fracture, rather than deform, under an applied force. An attempt to pinch the tie wings of a ceramic bracket in the manner described above for metal brackets, generally results in fracture of the tie wings or other portions of the bracket due to point loading of the bracket material by the pliers at the contact points.

For these and other reasons, such as heightened sensitivity to surface imperfections, various tools and methods have been proposed and used for debonding a bracket from a tooth. However, many tools and/or methods have not been fully satisfactory. For example, plier-type tools having metal jaws with sharp, opposed edges have been directed into the adhesive interface between the bracket base and the tooth. These tools separate the bracket base from the tooth surface by applying force directly to the adhesive interface.

U.S. Pat. No. 4,904,183, issued to Hannan, discloses a torquing tool having slotted ends which closely fit over the mesial and distal bracket surfaces. The user applies a twisting force about an axis generally normal to the bracket base and tooth surface to fracture the adhesive bond therebetween. This reference discloses that the tool is especially useful with brackets made of brittle, ceramic material.

U.S. Pat. No. 5,062,793, issued to Cleary, discloses a debonding instrument having a pair of arms with pulling sections adapted to engage a bracket behind its occlusal and gingival tie wings. The arms are connected to a lever, and movement of the lever enables the arms to simultaneously exert a pulling force on both of the wings along substantially their entire mesial-distal width in order to lift the bracket from the tooth in a straight line fashion. However, a torsional force, such as the quick twisting force or motion disclosed by Hannan, to be applied to the patient's tooth can be very uncomfortable for the patient. Further, depending on the bracket material and bond strength, these methods often require an excessive amount of force making it difficult to separate the bracket from the tooth. Such excessive force or methods may result in damage to the tooth surface or increased discomfort. Accordingly, dentists are hesitant to use such force, particularly in a torsional or pivoting action, to debond brackets.

U.S. Pat. Nos. 5,366,372 and 5,439,379, both issued to Hansen, disclose an orthodontic bracket having mesial and distal sections debonded from the tooth by pivoting the sections toward each other in respective arcs about a central reference axis extending in an occlusal-gingival direction. The mesial and distal sections are discrete and spaced apart from each other, or alternatively, integrally joined by a relatively thin web that bends and optionally fractures upon debonding. However, such design, when debonded by dentists may result in breakage or fracture of the bracket, even with less force than traditionally required, resulting in discomfort, and presenting potential harm from the pieces of the broken bracket in the patient's mouth.

An improved debonding technique has been described in U.S. Pat. No. 6,382,965 and discusses the use of a pivoting or rocking motion to break the bond between the adhesive and the bracket base. While this method has been quite successful, it would still be desirable to further decrease discomfort to the patient during debonding. In particular, it would be desirable to further reduce the amount of force needed to remove the bracket from the patient's tooth while retaining the necessary bonding forces during the orthodontic treatment. Another goal is to decrease the chances of having a nonmetal bracket break during debonding.

### SUMMARY OF THE INVENTION

The present invention provides an orthodontic bracket, and methods to debond the orthodontic bracket from a tooth surface, without suffering from the weaknesses and drawbacks of the brackets and debonding methods of the prior art. To this end, the present orthodontic bracket includes a base having a portion of the adhesive bonding surface modified so as to allow the bracket to be debonded or removed from a tooth surface with application of less force than generally required to debond prior art brackets. Decreased force reduces the propensity for breakage or fracture of the bracket during removal and lessens patient discomfort. In addition, the bracket eases debonding without a corresponding compromise in bond strength and bond reliability for the bracket. That is, the shear strength of the bond in an occlusal to gingival direction remains at levels suitable for the intended treatment procedure.

An orthodontic bracket of the invention generally comprises a bracket body and a base on the bracket body. The base includes mechanical bonding structure thereon. An adhesive is applied to and mechanically bonds with the mechanical bonding structure to secure the bracket body and the base to a tooth. A portion of the base has a bond strength with the adhesive which is reduced relative to the bond strength between the remainder of the base and the adhesive.

A method of debonding an orthodontic bracket attached with an adhesive to a tooth is provided in which the bracket includes a base with first and second areas of adhesion between the base and the tooth and the first area has reduced adhesion relative to the second area. The method comprises applying a debonding force to the bracket at the first area of adhesion between the bracket and the tooth and removing the bracket from the tooth.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 illustrates an exemplary embodiment of a bracket in accordance with the principles of the present invention.

FIG. 2 is a side elevation view showing a tool gripping an orthodontic bracket which is adhesively bonded to a tooth.

FIG. 3 is a fragmented enlarged view showing engagement of the jaws of the tool with the orthodontic bracket.

FIG. 3A is a fragmented, enlarged view of the exemplary bracket illustrated in FIG. 1 adhesively bonded to the tooth prior to removal with the tool.

FIG. 4 is a side elevation view similar to FIG. 3, but showing the tool rotated to break the adhesive bond between the bracket and the tooth.

FIG. 4A is a fragmented, enlarged view of the breakage of the adhesive bond along the gingival side of the bracket during removal of the bracket from the tooth.

### DETAILED DESCRIPTION OF THE INVENTION

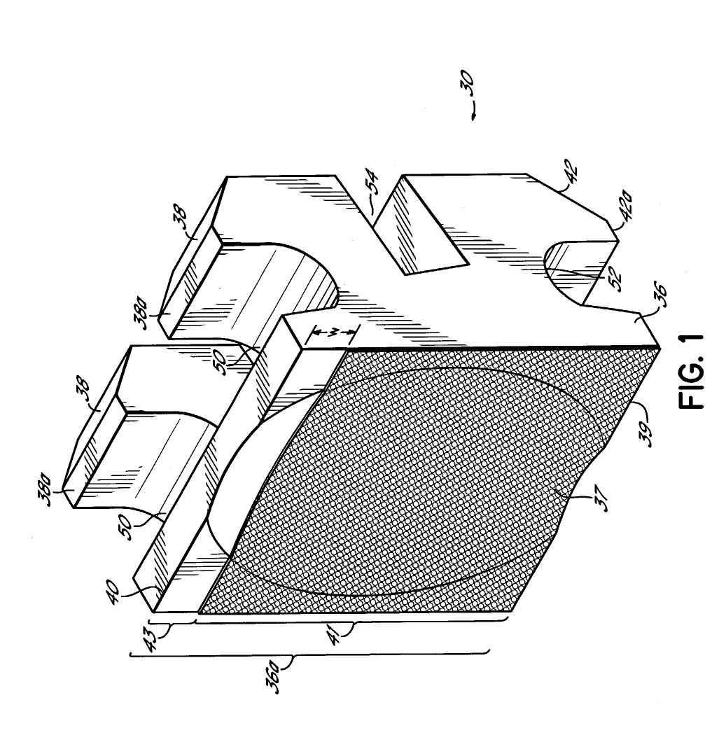

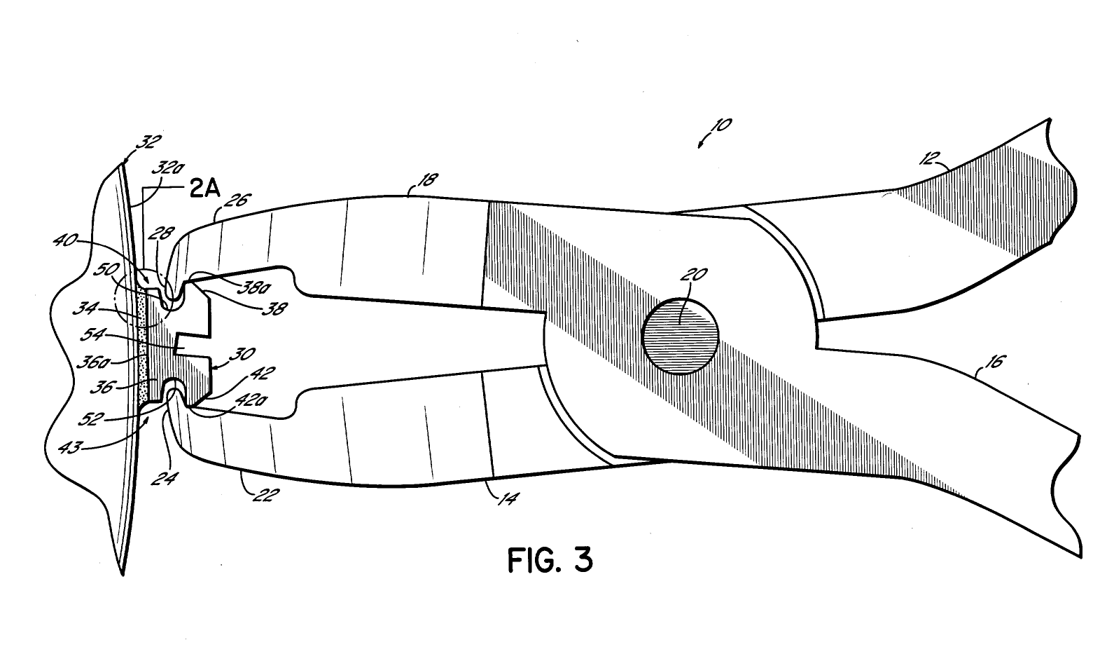

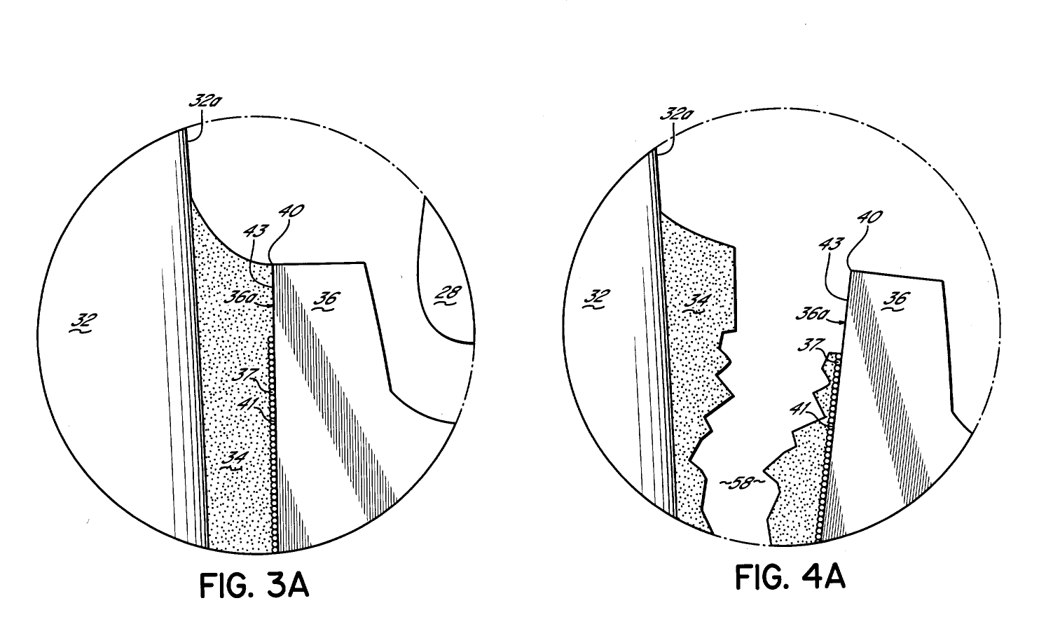

With reference to FIGS. 1-3, bracket 30 incorporates the principles of the present invention. Bracket 30 has a base 36, having a bonding surface 36a modified from bonding surfaces of traditional brackets. Bonding surface 36a is an adhesive bonding surface to which at least one adhesive layer 34 is used to bond bracket 30 to tooth surface 32a (FIG. 3). Adhesive layer 34 is schematically illustrated as a single layer, but may take many different forms, as generally appreciated by those of ordinary skill in the art. Advantageously, surface 36a is curved, as illustrated in FIG. 1, for better adhesive bonding to contours of a tooth surface 32a.

Generally the bond interface between the adhesive layer 34 and bracket base 36 is referred to as a bonding pad, and may include various elements to facilitate mechanically bonding bracket 30 to tooth surface 32a. For example, bonding structures for providing undercuts and/or increased bonding surface area are useful on surface 36a of base 36. In one embodiment of the invention, and as shown in FIG. 1, surface 36a includes bonding balls 37 which provide undercuts for mechanically bonding bracket 30 and tooth 32. The balls 37, are formed of conventional materials, as appreciated by those of ordinary skill in the art, and may have varying dimensions, such as having a diameter in the range from about 0.001 to about 0.005 inch. The present invention is not limited to mechanically bonding balls 37, as shown, and surface 36a may include other structures or projections 37 thereon to provide the necessary surface area and/or undercuts for mechanically securing bracket 30 to tooth 32. For example, surface 36a may include a mesh comprising interwoven filaments of suitable material, such as metal, adhered to surface 36a by a suitable method, such as by diffusion bonding, sintering, soldering, or welding.

Bracket surface 36a differs from similar bonding surfaces of prior art brackets in that the entire area of surface 36a is not completely or fully covered with the mechanically bonding balls 37 described above. To this end, and with reference to FIG. 1, a bonding area 41 along a major portion of surface 36a, extending from an occlusal edge 39 and continuing in a gingival direction to a gingival edge 40 of surface 36a, is provided with balls 37. The remaining surface area 43 along the gingival edge 40, and extending inwards in the occusal direction is free or void of balls 37. Area 43 is therefore not configured to provide a mechanical bond with adhesive layer 34 and, therefore, has less adhesion than the area covered with balls 37. As one alternative, area 43 may have a lower density of balls 37 (i.e., a lower number of balls per unit area) than the remainder of surface 36a. Adhesive layer 34 contacting area 43 will generally not form a chemical bond to surface 36a, particularly where surface 63a is formed of ceramic or metal materials. Thus, despite adhesive layer 34 contacting area 43, this portion of bracket base 36 does not form a significant bond with tooth surface 32a. In this fashion, area 43 provides an edge with lower bond strength for ease of removing bracket 30 from tooth surface 32a, and particularly by the methods provided in the present invention. As shown in FIG. 1, the width “w” of area 43 is about 0.01 to about 0.03 inch. In one embodiment, area 43 has a width ranging from about 0.015 to about 0.025 inch. By reducing the mechanical fixation along the gingival edge 40 of bracket 30, a reduced debonding force, such as up to about 30% less than the debonding force used to remove prior art brackets in accordance with U.S. Pat. No. 6,382,965, is sufficient to debond or remove bracket 30 from tooth 32. Non-bonded area 43 allows the breaking or fracturing of the adhesive layer 34 with a force smaller than traditionally needed for removal of the bracket. In addition, elimination or reduction of a mechanical bond along gingival edge 40 does not significantly affect the bond strength and/or bond reliability during treatment.

In another aspect of the invention, the entire surface area 36a of base of bracket 30, i.e., both areas 41 and 43, may be completely provided with balls 37 or other projecting structures for providing mechanically bonding undercuts on surface 36a. However, a portion of the balls 37 along the gingival edge 40, and defining a non-bonding area, similar to that of area 43, may be covered, coated, crushed or otherwise altered to reduce the mechanical bond with an adhesive layer 34. For example, a suitable coating (not shown) may be applied over a desired portion of the balls 37 on bracket base 36, extending in the occlusal direction from the gingival edge 40, for a distance in the range from about 0.015 to about 0.025 inch. Such a covering or coating, over balls 37, would prevent a mechanical bond between balls 37 and adhesive 34 along the gingival edge 40. This embodiment, therefore, reduces the force necessary for debonding or removing bracket 30 from a tooth surface 32a.

With reference to FIGS. 1 and 1A, bracket 30 further includes a plurality of tie wings 38, 40 and 42, 44 on opposite gingival and occlusal sides 46, 48. In this conventional configuration, a recess 50 is provided between base 36 and tie wings 38, 40 and an opposite recess is provided between base 36 and tie wings 32, 34. An archwire slot 54 runs in a mesial-distal direction between the respective pairs of tie wings 38, 40 and 42, 44. Most of the structure of bracket 30 is involved with and contacted during removal of bracket 30 from a tooth surface 32a with an appropriate tool or instrument, as described herein.

Bracket 30 may be formed of suitable materials, including, without limitation, metals, ceramic, plastic and other suitable materials. Particularly, crystalline materials, such as crystalline forms of aluminum oxide or other metal salts, are suitable materials for bracket 30. Single crystalline aluminum oxide (sapphire) brackets may be machined from a single, grown crystal and heat polished to eliminate surface flaws such as cracks and chips occurring during machining. Such an aluminum oxide crystalline bracket generally does not adhere or stick to conventional adhesives used by orthodontists and, therefore, provides advantages in accordance with the principles of the present invention.

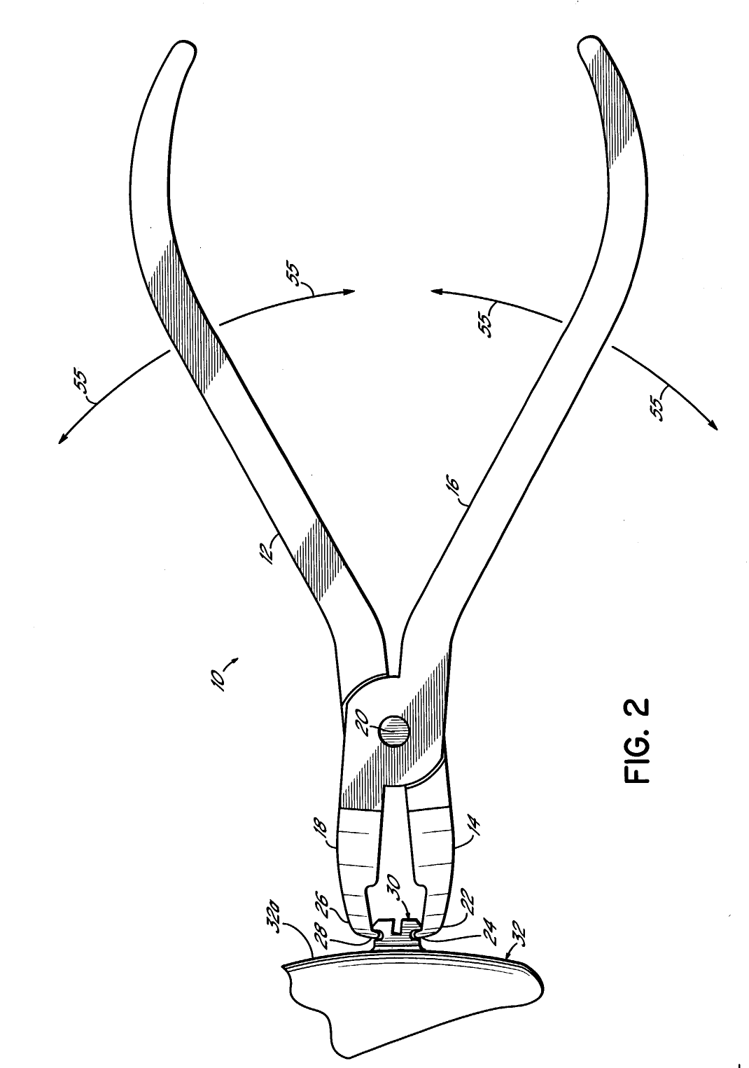

The brackets of the present invention may be removed from a tooth using a method employing any of a variety of tools, such as a plier-type tool or other tools disclosed. Preferred tools are shown in U.S. Pat. No. 6,382,965, the disclosure of which is incorporated herein by reference in its entirety. With reference to FIGS. 2 and 3, there is generally illustrated a tool 10 taking the general form of a pair of pliers having a first handle 12 preferably formed integrally with a first jaw 14 and a second handle 16 also preferably formed integrally with a second jaw 18. Handle and jaw 12, 14 are pivotally coupled to handle and jaw 16, 18 by a pivot pin 20. First jaw 14 includes a first bracket-engagement portion 22 having a first nib 24 and a second jaw 18 includes a second bracket engagement portion 26 having a second nib 28. Nibs 24, 28 project toward one another, as shown in FIG. 2, when engagement portions 22, 26 are in an engaged position gripping an orthodontic bracket 30 which has been adhesively affixed to an outer surface 32a of a tooth 32. Handles 12, 16 may be moved away from each other to disengage bracket 30 and moved towards one another, as illustrated by arrows 55, to engage or grip bracket 30.

With reference to FIG. 3A, there is shown in an enlarged, side elevated view, the adhesive bond interface between surface 36a, including its gingival edge 40, and a tooth surface 32a, illustrated in FIG. 3. As shown, gingival edge 40 of base surface 36a is free of mechanically bonding balls 37 or other mechanically bonding structure(s). In accordance with conventional techniques of adhering bracket 30 to surface 32, and as shown in FIG. 3A, adhesive layer 34 will contact the entire surface 36a of base 36 including area 40. Depending upon the material with which bracket 30 is made, the adhesive layer 34 will typically not form a chemical bond therewith, allowing the gingival edge 40 to be more easily pried away from the tooth 32 during removal of bracket 30. Bonding area 41 of surface 36a having balls 37 or other mechanically bonding structure(s) thereon, will form a mechanical bond with the adhesive layer 34 for adhering bracket 30 to tooth surface 32a.

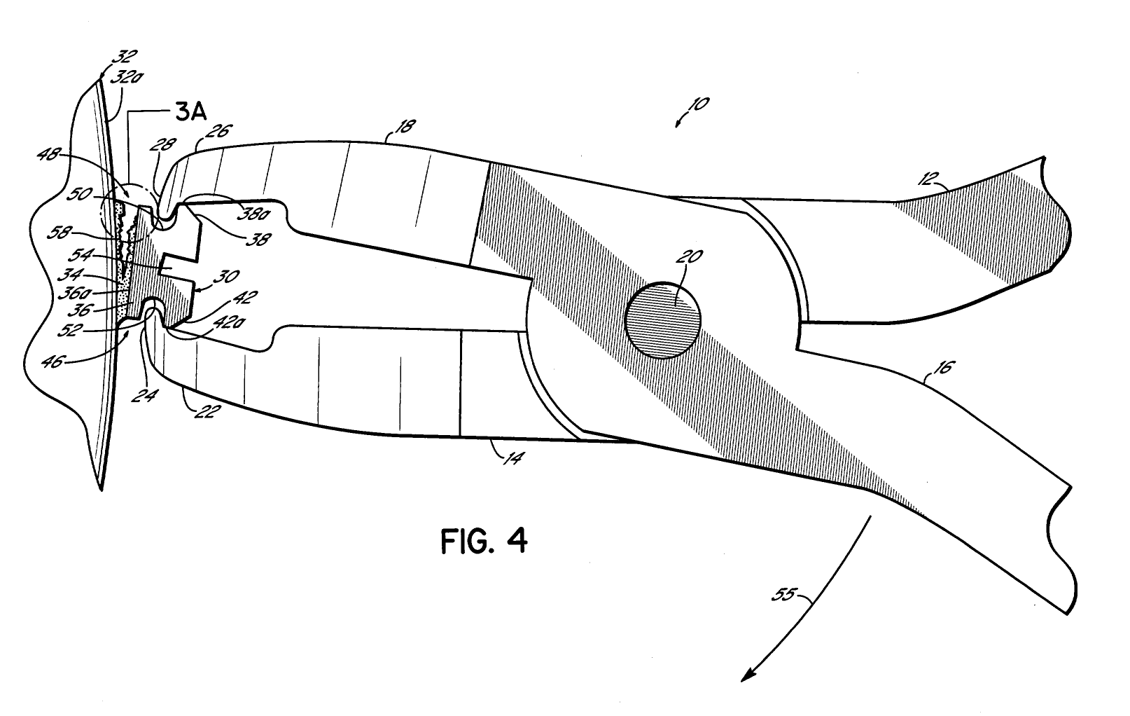

With reference to FIG. 4, there is shown, in a side elevated view, tool 10 in an engaged or gripping position with respect to debonding bracket 30 from tooth surface 32. As shown, nib 24 is retained within recess 52 and nib 28 is retained in recess 50. Bracket-engagement proportions 22, 26 also make full contact with tie wings 38, 40, 42, 44 along edges 38a, 40a, 42a, 44a. This full contact allows better gripping and avoids point loading of bracket 30 which could result in breaking or fracturing the bracket as compression is applied by jaws 14,18. To avoid further breaking or fracturing bracket 30, and especially breaking one or more of the tie wings 38, 40, 42, 44, at least bracket engagement portions 22, 26, including nibs 24, 28 may advantageously be formed from a relatively soft material as compared to bracket 30. As general guidelines, the modulus of elasticity of the material forming at least bracket-engagement portions 22, 26 should be less than about 15×10⁶ psi and preferably less than about 5×10⁶ psi. The Knoop microhardness of at least portions 22, 26 which engage in contact bracket 30 should be less than about 500 and, more advantageously, less than about 300. By comparison, a typical ceramic bracket will have a Knoop microhardness of at least about 1000, and more typically, about 2000 and have a modulus of elasticity in excess of 20×10⁶ psi.

FIG. 4 also illustrates rotation of tool 10 in a direction indicated by arrow 56 while grip pressure or compression is maintained on bracket 30 with engagement portions 22, 26 and opposed nibs 24, 28. A compressive grip is maintained on bracket 30 with nibs 24, 28 to permit a pivoting motion to be applied to bracket 30 and apply the required tensile force without having engagement portions 22, 26 and opposed nibs 24, 28 slip off bracket 30 while attempting to pivot bracket 30. This rotation in the direction of arrow 56 takes place about an axis line in a plane generally parallel to the plane of the base surface 36a, i.e., generally in the plane of tooth surface 32a as shown in FIG. 4a. In this manner, a tensile force is applied along the gingival edge 40 of bracket 30 in a direction away from tooth surface 32a. At the same time, compressive forces are applied to bracket 30 along the opposite occlusal edge 43 in a direction toward tooth surface 32a. In other words, unequal forces are applied in the tensile direction, i.e., a direction toward or away from tooth surface 32a, and a greater tensile force applied in a direction away from tooth surface 32a causes adhesive layer 32 to fracture or debond beginning along the gingival edge 40 of adhesive layer 34. Once a fracture 58 or debonding begins in this manner, the fracture essentially propagates along this adhesive interface to the opposite end of the bracket 30, and bracket 30 debonds from tooth surface 32a in a single, unbroken piece.

FIG. 4 further illustrates a portion of adhesive layer 34 remaining on tooth surface 32a, and another portion remaining on bracket base 36. Depending on the application, more or less of the adhesive layer 34 may be stripped from tooth surface 32a during this debonding process. The term “fracture” is used herein in a manner referring to each of these potential situations, i.e., some adhesive or no adhesive remaining on the tooth. A similar method may be performed in accordance with the invention by gripping mesial and distal sides of bracket 30 with bracket engagement portions 22, 26 and thereafter pivoting tool 10 about an axis generally lying in the plane of base surface 36a. However, depending on the dimensions of the tool used, there may be a potential for losing the grip on the mesial and distal sides of bracket 30. It will be appreciated, however, that such a method is possible in accordance with the inventive concepts, especially through the development of other gripping or prying tools adapted to the bracket.

The benefits and advantages of the brackets and methods for debonding the brackets in accordance with the principles of the present invention will be further appreciated in light of the following examples.

### EXAMPLES

Methods and Materials:

Fifty-five orthodontic brackets were prepared for evaluating: (1) adhesive bond strength when bonded to a tooth; and (2) debonding forces necessary for removal of the bracket from the tooth. The adhesive bonding surfaces of all fifty-five brackets were cleaned and prepared for coating with mechanically bonding balls as described above. Thirty brackets were prepared as the Experimental Group having modified bases in accordance with the present invention, and had lines of balls removed from the bonding surface of the bracket base, beginning from the gingival edge and extending in the occlusal direction for a distance of about 0.01 to about 0.02 inch. Twenty-five brackets were not modified, in that their bracket bonding surfaces were completely covered with the balls, spanning the entire bonding surface from the gingival edge to the occlusal edge, and were designated as the Stock Group for comparison with the Experimental Group. The balls were coated onto the bonding surfaces of the bracket bases and removed by the process described below.

Bonding Ball Coating and Removal Process

The bonding surface of the base of all brackets were first completely coated with mechanically bonding balls. To coat the bonding surfaces, adhesive was applied to the surface by conventional methods. The brackets were then dipped into a collection of balls, removed, and the excess balls were shaken off of the bracket. The brackets were then placed on a ceramic tray and inserted into an oven where the excess adhesive on each bracket was burned off. The balls at this point were not diffusion bonded to the bracket. The Experimental Group was removed from the ceramic tray and oriented towards their gingival side and placed on sticky blocks. Lines of balls spanning a distance ranging from about 0.01 to about 0.02 from the gingival side of each bracket in the Experimental Group were removed and that portion of the bonding surface cleaned. Removal of the balls was accomplished with a toothpick, however, other suitably modified tools may be used. The Experimental Group of brackets was again placed on a ceramic tray, alongside the Stock Group and the balls on the base surface were diffusion bonded to the bracket base in a diffusion furnace. Each individual bracket was then mounted on a bovine tooth using Solo+Enlight® adhesive and cured for about 20 seconds with a 501 light. The bracket/tooth combinations were placed in a water bath for a minimum of 24 hours to allow proper hardening of the adhesive prior to bond evaluation.

Test Methods

Shear bond strength along both the occlusal and gingival sides of bonded brackets were tested using the Instron test method at cross head speeds of about 1.0 mm per minute. The brackets were debonded from the tooth using Inspire® debonding pliers, available from Ormco Corporation, California, at about 100 mm per minute movement of the handle. Removal was accomplished by torquing the brackets in the gingival to occlusal direction, that is, upon engagement with the bracket, the pliers were rotated or pivoted away from the tooth using the occlusal edge as a pivot. As a result, the bond was initially fractured along the gingival edge of the bracket and progressed in the occlusal direction to fully debond the bracket.

Tests Results

Table 1 represents the results obtained when a debonding force was applied with the torquing method discussed above for removal of the bracket. Table 1 also presents results of shear forces applied along the occlusal edge in a gingival direction for testing bond strength necessary during patient treatment. The Experimental Group of brackets having their gingival edges cleaned, and the unmodified, Stock Group were both exposed to a shear force or load, measured in kg.

TABLE 1

| Bracket | Test | | | |
|---|---|---|---|---|
| Type | Description | Load, Kg | Variation | Std. Dev. |
| Stock Group | Debonding | .22 | 0 | .02 |
| | Torque | | | |
| Experimental | Debonding | .16 | 27% | .04 |
| Group | Torque | | | |
| Stock Group | Shear Load | 18.8 | 0 | 3.4 |
| Experimental | Shear Load | 19.3 | 2% | 4.8 |
| Group | | | | |

As seen in Table 1, the force required to debond the Experimental Group of brackets, from the gingival edge in the occlusal direction, was about 0.16 kg or about 27% less than the force (0.22 kg) required to debond the Stock Group of brackets from the tooth. However, the difference in resistance to shear forces along the occlusal edge in the gingival direction, between the Experimental Group of brackets and the Stock Group of brackets was negligible and insignificant (0.5 kg is within the margin of error for the measurement as shown by the individual standard deviations exceeding the difference between the groups). A variation of only 2% for force values of about 19 kg is small and well within the measurement error. Also worth noting is the tremendous difference in the load found sufficient to debond the bracket from the gingival edge and load resisted along the occlusal edge. The occlusal load tabulated was that which the bracket was able to withstand before fracturing along the occlusal edge. Thus, removal of mechanically bonding adhesion structure, such as the balls, along the gingival edge of the bracket reduces, up to about 27% or more depending on the amount removed, the force necessary for debonding and removing the bracket from a tooth, while insignificantly affecting the bond strength and bond reliability, and therefore bracket stability when adhered to a tooth.

While the present invention has been illustrated by the description of preferred embodiments, and while these embodiments have been described in some detail, it is not the intention of the applicant to restrict or in any way limit the scope of the appended claims to such detail. Additional advantages and modifications will readily appear to those skilled in the art. Various features in the embodiments described herein may be combined in different manners depending upon the desired characteristics. This has been a description of the present invention, along with the preferred methods of practicing the present invention as currently known. However, the invention should only be defined by the appended claims wherein I claim:

1. A method of debonding an orthodontic bracket attached with an adhesive to a tooth, the bracket having a base with first and second areas of adhesion between the base and the tooth and with the first area having reduced adhesion relative to the second area, the method comprising:
applying a debonding force to the bracket at the first area of adhesion between the bracket and the tooth, and
removing the bracket from the tooth.

2. The method of claim 1, wherein applying a debonding force further comprises:
engaging at least a first side of the bracket,
pivoting the bracket about an axis lying in a plane generally parallel to a plane defined by the base to apply a tensile force to a first side of the bracket in a direction away from the tooth, the tensile force applied to the first side being substantially greater than any tensile force directed away from the tooth which may be applied to the side of the bracket located opposite to the first side, and
fracturing the adhesive between the bracket and the tooth under the tensile force applied to the first side of the bracket to remove the bracket from the tooth.

3. The method of claim 2, wherein the step of engaging at least the first side further comprises:
engaging said first side and an opposite second side with a tool, and
applying compressive forces to the first and second sides with the tool to grip the bracket prior to pivoting the tool.

4. The method of claim 3, wherein the step of engaging said first side and said opposite second side with the tool further comprises gripping the first and second sides of the bracket with at least a portion of the tool formed from a material of sufficiently reduced hardness relative to the bracket to avoid fracturing the bracket during the pivoting step.

5. The method of claim 4, wherein the step of engaging said first side and said opposite second side with the tool further comprises engaging recesses on the first and second sides of the bracket with respective projections extending from said tool.

6. The method of claim 1, wherein the first area of adhesion is located along a gingival edge of the bracket and the method further comprises:
pivoting the bracket away from the tooth using an occlusal edge of the bracket as a pivot.

7. The method of claim 1, wherein the first area of adhesion is located adjacent a first edge of the base and the second area of adhesion is located adjacent a second edge of the base which is opposite to the first edge, and the method further comprises:
pivoting the first edge of the base away from the tooth using the second edge of the bracket as a pivot.

8. The method of claim 1, wherein the bracket is metal.

9. The method of claim 1, wherein the bracket is nonmetal.

10. The method of claim 9, wherein the bracket is ceramic.

11. An orthodontic bracket comprising:
a bracket body,
a base on said bracket body, said base having mechanical bonding structure thereon, and
an adhesive applied to and mechanically bonded with said mechanical bonding structure to secure said bracket body and said base to a tooth,
wherein a portion of said base has a bond strength with said adhesive which is reduced relative to the bond strength between the remainder of said base and said adhesive.

12. The bracket of claim 11, wherein said mechanical bonding structure comprises a plurality of balls fixed to said base.

13. The bracket of claim 12, wherein the density of balls on said portion of said base is less than the density of balls on the remainder of said base.

14. The bracket of claim 13, wherein said portion of said base is void of balls.

15. The bracket of claim 11, wherein said portion of said base is along an edge of said base.

16. The bracket of claim 15, wherein said portion of said base is along at lease one of a gingival and an occlusal edge of said base.

17. The method of claim 11, wherein the bracket is metal.

18. The method of claim 11, wherein the bracket is nonmetal.

19. The method of claim 18, wherein the bracket is ceramic.

20. An orthodontic bracket for bonding to a tooth with adhesive, comprising:
a bracket body, and
a base on said bracket body, said base having mechanical bonding structure thereon for mechanically bonding with the adhesive, said mechanical bonding structure configured such that said base will have different bond strengths with the adhesive in different areas of said base.

21. The bracket of claim 20, wherein the mechanical bonding structure is configured such that an area of the base adjacent to an edge thereof will have a reduced bond strength with the adhesive relative to another area of the base.

22. The bracket of claim 20, wherein said mechanical bonding structure comprises balls.

23. The bracket of claim 22, wherein the density of balls on one area of said base is less than the density of balls on another area of said base.

24. The bracket of claim 23, wherein said one area of said base is void of balls.

25. The bracket of claim 23, wherein said one area is located along an edge of said base.

26. The bracket of claim 25, wherein said edge is at least one of said gingival edge and said occlusal edge.

27. An orthodontic bracket comprising:
a bracket body; and
a base on said bracket body and configured for bonding to a tooth of a patient and further configured for debonding from the tooth such that less debonding force is required in one direction to debond the bracket from the tooth than in an opposite direction.

28. The bracket of claim 27, wherein said base is configured such that less debonding torque is required in a gingival to occlusal direction than in an occlusal to gingival direction to debond the bracket from the tooth.
